(19) United States
(12) Patent Application Publication
(10) Pub. No.: US 2024/0289640 A1
(43) Pub. Date: Aug. 29, 2024

(54) SIMULATED ANNEALING DEVICE AND SIMULATED ANNEALING METHOD

(71) Applicant: NEC Corporation, Minato-ku, Tokyo (JP)

(72) Inventor: Takuya ARAKI, Tokyo (JP)

(73) Assignee: NEC Corporation, Minato-ku, Tokyo (JP)

(21) Appl. No.: 18/569,705

(22) PCT Filed: Jun. 18, 2021
(86) PCT No.: PCT/JP2021/023239

§ 371 Date: Dec. 13, 2023

(51) Int. Cl. G06N 5/01; G06N 10/80

(52) U.S. Cl. CPC G06N 5/01; G06N 10/80

(57) ABSTRACT

A simulated annealing device includes a solving unit which solves a SAT (Boolean Satisfiability Testing) expressed in a CNF (Conjunctive Normal Form) form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.

### TECHNICAL FIELD

The present invention relates to a simulated annealing device, a simulated annealing method, and a simulated annealing program.

### BACKGROUND ART

A quantum computer capable of solving combinatorial optimization problems at high speed using a quantum annealing method is being studied. The quantum computer represents the combinatorial optimization problem as an Ising model and uses quantum superposition to search for the state that minimizes the energy function corresponding to the objective function of the combinatorial optimization problem.

The quantum computer solves combinatorial optimization problems using the energy function in the Ising model as input. Examples of combinatorial optimization problems include the traveling salesman problem, knapsack problem, graph partitioning problem, and nurse shift scheduling problem. Combinatorial optimization problems can also be other problems.

The Ising model is a statistical mechanical model that represents the behavior of spins in a magnetic material. In the Ising model, individual spin states are represented by “1” or “−1”.

FIG. 9 is an explanatory diagram showing an example of a partially-coupled Ising model. As shown in FIG. 9, the Ising model consists of lattice points that indicate one of two spin states (“1” or “−1”).

For example, the arrows at the lattice points shown in FIG. 9 represent spins. Up arrows represent spins in the state of “1”. Down arrows represent spins in the state of “−1”.

The lattice points shown in FIG. 9 interact with each other. When the combinatorial optimization problem is solved, the spin orientation changes so that the energy function in the Ising model becomes smaller.

The energy function in the Ising model is represented as in Equation (1) below.

$$\begin{matrix}[ Math . 1 ] & \\ {H}_{Ising} = {\sum }_{i j} {J}_{i j} {s}_{i} {s}_{j} + {\sum }_{i} {h}_{i} {s}_{i} & Equation ( 1 )\end{matrix}$$

The sᵢ, sⱼ in Equation (1) are variables representing the spin states. Also, Jᵢⱼ is a constant according to i, j. Also, hi is a constant according to i.

QUBO (Quadratic Unconstrained Binary Optimization) is also known as a model in which each spin state is represented by “1” or “0”. The energy function in the Ising model and the energy function in QUBO are mutually convertible.

The energy function in QUBO is represented as in Equation (2) below.

$$\begin{matrix}[ Math . 2 ] & \\ \begin{matrix}{H}_{Q U B O} = {\sum }_{i j} {Q}_{i j} {x}_{i} {x}_{j} & ( x = ( s + 1 ) / 2 )\end{matrix} & Equation ( 2 )\end{matrix}$$

The xᵢ, xⱼ in Equation (2) are variables representing the spin states. Also, Qᵢⱼ is a constant according to i, j.

Currently, quantum computers that are large enough to solve real-world combinatorial optimization problems have not been realized. However, with the advent of quantum computers, a study is being conducted on the application of combinatorial optimization technology.

For example, in order to obtain solutions to various combinatorial optimization problems in a generalized manner, we currently use a simulated annealing method (annealing method, also referred to as SA method below) that uses the Ising model and the energy function in QUBO as input. When the SA method is used, solutions to combinatorial optimization problems can be obtained even on classical computers.

If the combinatorial optimization problem to be solved is represented in Ising model or QUBO form, the SA method can handle various combinatorial optimization problems. Combinatorial optimization problems formulated in Ising model or QUBO form can be solved by both quantum and classical computers.

The SA method is a general-purpose method for solving combinatorial optimization problems in an approximate manner. The SA method solves combinatorial optimization problems with the following four processes as one cycle.
1. select one spin
2. compute the change amount in energy Δ when flipping the selected spin
3. with transition probability min(exp(−Δ/T), 1), accept spin flip
4. if the flip is accepted, flip the selected spin

Specifically, the SA method flips the spin orientation selected in step 2 above from “−1” to “1” or “1” to “−1” and compute the change amount in energy Δ when the spin is flipped.

The SA method then accepts the spin flip in step 3 above if the computed Δ is negative. If the computed Δ is positive, the SA method accepts the spin flip with the probability computed as above.

Next, the SA method flips the spin selected in step 4 above if the flip is accepted. In other words, the SA method searches for a state where the energy becomes smaller while changing the orientations of the spins (variables) one by one. Note that T is a temperature parameter.

FIG. 10 is an explanatory diagram showing an example of the process of solving a combinatorial optimization problem by the SA method. The curves within each rectangle shown in FIG. 10 represent the energy function. The black circles in each rectangle shown in FIG. 10 are examples of the energy value when the solution obtained by the SA method is used.

The graph shown in FIG. 10 represents the change in the temperature parameter T with the passage of time in the process of solving the combinatorial optimization problem. The graph shown in FIG. 10 represents the reduction of the temperature parameter T with the passage of time.

The SA method starts the process of solving with a random combination of multiple spin orientations (solution) and transitions by evaluating nearby solutions. Since a temperature parameter T is introduced, the SA method can transition in the direction of a solution which is evaluated as worse when T is high.

For example, as in the early stage of the process of solving shown in FIG. 10, the SA method can also cross high peaks in the energy function if T is high. By crossing the high peaks and transitioning in the direction of the solution which is evaluated as worse as well, the SA method can avoid obtaining the local optimal solution as the final solution to the combinatorial optimization problem.

As the temperature parameter T is lowered, the peaks to be crossed in the energy function become progressively lower, as in the middle stage of the process of solving shown in FIG. 10. In other words, the number of transitions in the direction of the solution which is evaluated as worse is reduced.

As the temperature parameter T is further lowered, the SA method is unable to cross the peaks in the energy function. Finally, the SA method stabilizes with a high probability of transitioning to the deepest valley bottom in the energy function, as in the late stage of the process of solving shown in FIG. 10.

The following is an explanation of the process of solving a combinatorial optimization problem, using the case of obtaining a solution to the traveling salesman problem by the SA method as an example. The traveling salesman problem is the problem of what order to go around each city in order to travel the minimum distance. In the traveling salesman problem, N² spins (variables) are defined for N number of cities (N is a positive integer). Each spin indicates the presence of a salesman at point k at time t.

FIG. 11 is an explanatory diagram showing an example of cities subject to the traveling salesman problem. The black circles shown in FIG. 11 represent cities. The lines shown in FIG. 11 represent routes. In the case of the example shown in FIG. 11, the traveling salesman problem is a problem to determine in what order one can travel around city A, city B, city C, and city D with the minimum travel distance.

First, an equation representing the energy in the traveling salesman problem is generated. In this example, the traveling salesman problem is represented in QUBO form. The energy function in the traveling salesman problem is generated by adding a constraint term with high weight to the objective function. The reason for adding the constraint term to the objective function is to impose a constraint condition on the optimization target (energy).

Equation (3), shown below, for example, is generated as the energy function in the traveling salesman problem.

$$\begin{matrix}[ Math . 3 ] & \\ H = α {\sum }_{v = 1}^{n} {( 1 - {\sum }_{j = 1}^{N} {x}_{v , j} )}^{2} + α {\sum }_{j = 1}^{n} {( 1 - {\sum }_{v = 1}^{N} {x}_{v , j} )}^{2} + β {\sum }_{( u v ) ∈ E} {W}_{u v} {\sum }_{j = 1}^{N} {x}_{u , j} {x}_{v , j + 1} & Equation ( 3 )\end{matrix}$$

In Equation (3), j represents time. Also, v and u represent cities. In addition, x_{v,j} is a variable that represents whether or not the salesman is present in city v at time j. x_{v,j} corresponds to a spin. That is, x_{v,j}=1 represents that the salesman is present in city v at time j. Also, x_{v,j}=0 represents that the salesman is not present in city v at time j.

In Equation (3), Wᵤᵥ is the distance between city u and city v. Wᵤᵥ is predetermined as a constant for each pair of cities. Also, α and β are predetermined as constants.

The first term on the right side in Equation (3) represents the constraint that a salesman may only pass through the same city once, i.e., never more than once.

The second term on the right side in Equation (3) represents the constraint that a salesmen can only be in one city at a time.

The third term on the right side in Equation (3) represents the sum of the distances between the cities that the salesman passes through. The third term on the right side is the objective function to be minimized.

Once the energy function in QUBO is obtained, the SA method identifies the state of each spin when the energy is at a minimum. Once the state of each spin when the energy is at a minimum is identified, the optimal solution to the traveling salesman problem is obtained.

FIG. 12 is a schematic diagram showing an example of the representation of the state of each spin in the traveling salesman problem. The “1” or “0” shown in FIG. 12 corresponds to the spin (variable).

The spins shown in FIG. 12 correspond, from left to right, to city A, city B, city C, and city D, respectively. Also, the spins shown in FIG. 12 correspond, from top to bottom, to time 1, time 2, time 3, and time 4, respectively. In other words, FIG. 12 shows the paths around city A, city C, city B, and city D in that order.

As described above, if the energy functions in the Ising model and QUBO are applied to SA, solutions to various combinatorial optimization problems can be obtained in a generic manner. However, when the original combinatorial optimization problem is converted to Ising model or QUBO form, the problem, that the problem space which is the range of solution search increases, occurs.

For example, the original problem space of the traveling salesman problem is N! if the number of cities is N. However, when the traveling salesman problem is converted to Ising model form, etc., the problem space increases to the N² power of 2.

The SA method also computes the change amount in energy Δ for any of the many combinations of spins that do not satisfy the constraints in the problem space. If the change amount in energy Δ becomes large due to the constraint term, the SA method removes the combinations which do not satisfy the constraints from the candidate solutions.

Due to the fact that the above a is set to a large value, etc., the computed change amount in energy Δ becomes large even when only one spin is flipped in a combination that does not satisfy the constraints. In other words, it is difficult for the SA method to transition from one local solution to another solution due to the steepness of the solution space caused by the constraint term of the Ising model, where the change amount in energy Δ increases too much without the constraint being satisfied even when only one spin is flipped.

For these reasons, when the SA method solves a combinatorial optimization problem using an energy function including constraint terms in the Ising model or QUBO, the accuracy of the obtained solution may deteriorate or the computation time required to obtain an optimal or suboptimal solution may increase.

A solution system to solve the above problem is described in Patent Literature (PTL) 1. The solution system described in PTL 1 flips the spins to satisfy the constraint terms.

For example, in the case of the traveling salesman problem, the solution system described in PTL 1 uses the one-hot constraint, which ensures that only one spin in a combination of spins (variables) satisfies “1”. The solution system described in PTL 1 that uses the one-hot constraint flips only one “1” spin, while simultaneously flipping the other “0” spins.

Non Patent Literature (NPL) 1 describes a method for converting the constraint to SAT (Boolean Satisfiability Testing).

### CITATION LIST

### Patent Literature

PTL 1: International Publication No. WO 2021/059338

### Non Patent Literature

NPL 1: Niklas Een and Niklas Sorensson, “Translating Pseudo-Boolean Constraints into SAT,” Journal on Satisfiability, Boolean Modeling and Computation, 2(1-4), 1-26, 2006.

### SUMMARY OF INVENTION

### Technical Problem

However, the solution system described in PTL 1 does not address flipping spins so that all constraints are satisfied when multiple constraints are imposed on the combinatorial optimization problem.

FIG. 13 is a schematic diagram showing another example of the representation of the state of each spin in the traveling salesman problem. For example, suppose that the solution system described in PTL 1 flips the circled variable x_{C,1}=0 in each of the spin state shown in the left of FIG. 13.

When the variable x_{C,1} flips from “0” to “1”, the solution system described in PTL 1 flips other variables so that the variable x_{C,1} satisfies the directly related one-hot constraint. Specifically; the solution system described in the PTL 1 flips the circled variable x_{A,1} from “1” to “0” and the circled variable x_{C,2} from “1” to “0”, as in each of the spin state shown in the right of FIG. 13, respectively.

However, when the variables x_{A,1} and x_{C,2} are flipped, as in each of the spin state shown in the right of FIG. 13, the variables for time 2 and city A surrounded by dashed lines all become “0”. In other words, the one-hot constraint on time 2 and the one-hot constraint on city A are no longer satisfied, respectively.

As described above, it is easy for the solution system described in PTL 1 to flip other variables so that constraints directly related to the variable to be tried to flip are satisfied.

However, it is difficult for the solution system described in PTL 1 to flip other variables so that other constraints not directly related to the variable to be tried to flip are also satisfied. NPL 1 also does not describe flipping spins so that all constraints are satisfied when multiple constraints are imposed on the combinatorial optimization problem.

Therefore, it is an object of the present invention to provide a simulated annealing device, a simulated annealing method, and a simulated annealing program that can easily obtain candidate solutions that satisfy all of the multiple constraints imposed on a combinatorial optimization problem.

### Solution to Problem

A simulated annealing device according to the present invention is a simulated annealing device includes a solving means which solves a SAT (Boolean Satisfiability Testing) expressed in a CNF (Conjunctive Normal Form) form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.

A simulated annealing method according to the present invention is a simulated annealing method includes solving a SAT (Boolean Satisfiability Testing) expressed in a CNF (Conjunctive Normal Form) form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.

A simulated annealing program according to the present invention is a simulated annealing program causing a computer to execute a solving process of solving a SAT (Boolean Satisfiability Testing) expressed in a CNF (Conjunctive Normal Form) form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.

### Advantageous Effects of Invention

According to the present invention, it is possible to easily obtain candidate solutions that satisfy all of the multiple constraints imposed on a combinatorial optimization problem.

### BRIEF DESCRIPTION OF DRAWING

FIG. 1 is a block diagram showing an example of the configuration of a simulated annealing device of the example embodiment of the present invention.

FIG. 2 is an explanatory diagram showing an example of the process that the SAT solving unit 112 solves for the SAT.

FIG. 3 is an explanatory diagram showing an example of searching for candidate solutions in the process of solving a combinatorial optimization problem by the SAT solving unit 112.

FIG. 4 is an explanatory diagram showing another example of searching for candidate solutions in the process of solving a combinatorial optimization problem by the SAT solving unit 112.

FIG. 5 is a flowchart showing an operation of the combinatorial optimization problem solving process by the simulated annealing device 100 of the present example embodiment.

FIG. 6 is a flowchart showing another operation of the combinatorial optimization problem solving process by the simulated annealing device 100 of the present example embodiment.

FIG. 7 is an explanatory diagram showing an example of a hardware configuration of a simulated annealing device according to the present invention.

FIG. 8 is a block diagram showing an overview of a simulated annealing device according to the present invention.

FIG. 9 is an explanatory diagram showing an example of a partially-coupled Ising model.

FIG. 10 is an explanatory diagram showing an example of the process of solving a combinatorial optimization problem by the SA method.

FIG. 11 is an explanatory diagram showing an example of cities subject to the traveling salesman problem.

FIG. 12 is a schematic diagram showing an example of the representation of the state of each spin in the traveling salesman problem.

FIG. 13 is a schematic diagram showing another example of the representation of the state of each spin in the traveling salesman problem.

### EXAMPLE EMBODIMENTS

### Description of Configuration

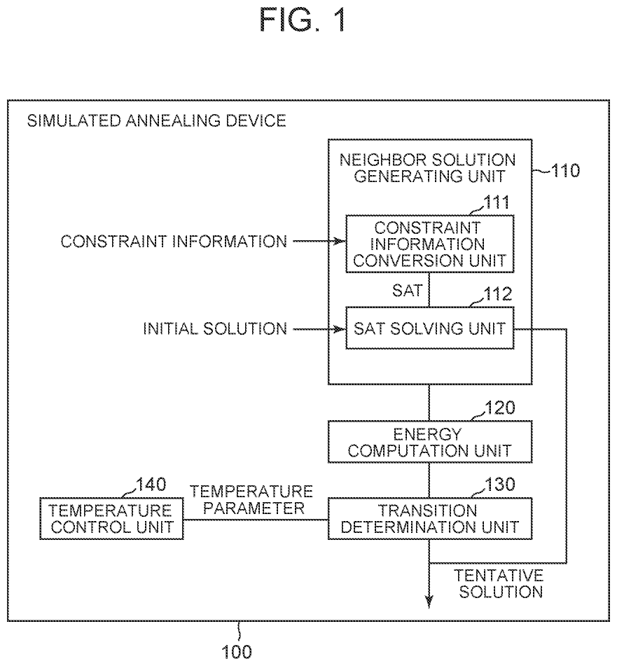

Hereinafter, an example embodiment of the present invention will be described with reference to the drawings. FIG. 1 is a block diagram showing an example of the configuration of a simulated annealing device of the example embodiment of the present invention.

As shown in FIG. 1, the simulated annealing device 100 of this example embodiment includes a neighbor solution generating unit 110, an energy computation unit 120, a transition determination unit 130, and a temperature control unit 140.

As shown in FIG. 1, the neighbor solution generating unit 110 of this example embodiment includes a constraint information conversion unit 111 and a SAT solving unit 112.

The simulated annealing device 100 of this example embodiment is characterized by the use of a SAT solver to search for combinations of spins (variables) that satisfy all constraints imposed on the combinatorial optimization problem.

The SAT is the problem of determining whether or not there is a value that makes a given logical formula true. The SAT solver is a system that solves the SAT.

The SAT is also given in the Conjunctive Normal Form (CNF) form. The SAT given in the CNF form is described, for example, as in Equation (4) below:

$$\begin{matrix}[ Math . 4 ] & \\ ( {x}_{1} ∨ ¬ {x}_{2} ) ∧ ( {x}_{1} ∨ {x}_{3} ∨ ¬ {x}_{4} ) ∧ ( ¬ {x}_{3} ∨ ¬ {x}_{5} ) ∧ ( ¬ {x}_{3} ∨ {x}_{5} ) ∧ ( {x}_{3} ∨ {x}_{4} ) & Equation ( 4 )\end{matrix}$$

Note that xᵢ in Equation (4) is a variable that represents either true or false. In addition, “∧”, “∨”, and “¬” in Equation (4) mean OR, AND, and NOT, respectively. In addition, (x₁ ∧¬x₂), etc. in Equation (4) are called clauses.

That is, in the SAT given in the CNF form, clauses, where each variable is combined by OR, are combined by AND with each other. The SAT solver returns xᵢ that satisfies the SAT given in the CNF form. If no variable satisfies the SAT, the SAT solver returns an unsatisfiable.

The simulated annealing device 100 of this example embodiment generates sets of values of variables that satisfy the constraints using the SAT solver by considering xᵢ as a variable in QUBO and the SAT given in the CNF form as constraints imposed on the combinatorial optimization problem, respectively. The functions of each component of the simulated annealing device 100 of this example embodiment are described below.

The constraint information conversion unit 111 of the neighbor solution generating unit 110 has the function of converting the constraint information indicating the constraints imposed on the combinatorial optimization problem to be solved into the SAT expressed in the CNF form. The constraint information is input to the constraint information conversion unit 111.

Methods for expressing one-hot constraints, etc. in CNF are described, for example, in NPL 1. In NPL 1, for example, the following Equation (5), which is a generalized constraint, is considered for conversion.

$$\begin{matrix}[ Math . 5 ] & \\ {w}_{1} {x}_{1} + {w}_{2} {x}_{2} + … + {w}_{n} {x}_{n} \geq k & Equation ( 5 )\end{matrix}$$

The constraints shown in Equation (5) are converted to one-hot constraints by converting “wᵢ” to “1” and “≥k” to “=1” in Equation (5), respectively.

The constraint information conversion unit 111 inputs the SAT expressed in the generated CNF form to the SAT solving unit 112.

The SAT expressed in the CNF form, to which constraints other than one-hot constraints have been converted, may be input directly from the outside to the SAT solving unit 112. In the case that the SAT expressed in the CNF form is input directly from the outside to the SAT solving unit 112, the neighbor solution generating unit 110 does not have to include the constraint information conversion unit 111.

The SAT solving unit 112 has the function of solving the SAT expressed in the input CNF form. That is, the SAT solving unit 112 is a component which is equivalent to the SAT solver. The SAT solving unit 112 inputs the candidate solutions to the combinatorial optimization problem obtained by solving to the energy computation unit 120.

The energy computation unit 120 has the function of computing the change amount in energy Δ based on the input candidate solutions, which is the process in step 2 above. The energy computation unit 120 handles, for example, an energy function as shown in Equation (3).

The energy function handled by the energy computation unit 120 does not have to include a constraint term. The reason for this is that the constraint term in the energy function becomes zero when the candidate solutions are substituted because the candidate solutions input to the energy computation unit 120 always satisfy the constraints. The energy computation unit 120 inputs the computed change amount in energy Δ to the transition determination unit 130.

The transition determination unit 130 has the function of determining whether a flip of the spin in the candidate solution is accepted or not using the input change amount in energy Δ, which is the process in step 3 above. If the flip is accepted, the transition determination unit 130 flips the spins in the candidate solutions, which is the process in step 3 above.

The temperature control unit 140 has the function of controlling the temperature parameter T. As shown in FIG. 10, the temperature control unit 140 decreases the temperature parameter T with the time passage of the process of the solving.

In general, the SAT solver terminates the process when it has found one SAT solution. In SA, however, after one variable flips from the current combination of variables, it is required to obtain a combination that satisfies the constraints while leaving the other variables unchanged as much as possible.

The following is a description of the specific operation of the SAT solving unit 112 of this example embodiment to achieve the above objectives. The SAT solving unit 112 of this example embodiment operates according to an algorithm called DPLL (Davis-Putnam-Logemann-Loveland).

The SAT solving unit 112 according to DPLL search for a confirmed xᵢ in the SAT expressed in the CNF form. If there is no confirmed xᵢ, the SAT solving unit 112 selects one variable from xᵢ and sets the selected xᵢ to true or false.

The SAT solving unit 112 then substitutes the confirmed xᵢ to the SAT expressed in the CNF form. The substitution of the confirmed xᵢ results in a new confirmed xᵢ.

For example, in the case of a clause (x₁ ∧x₂ ∧x₃), if x₁ and x₂ are false, then x₃ is confirmed to be true because the clause itself must be true. Such an operation to confirm a new variable is called unit propagation. The SAT solving unit 112 obtains a combination of variables by repeating unit propagation.

If an inconsistency occurs, such as both ¬xᵢ and xᵢ must be true, then the variable selected earlier was incorrectly set to true or false. Therefore, if an inconsistency occurs, the SAT solving unit 112 backtracks to the previously set variable and changes the value of the variable.

As methods for speeding up the SAT solver, other methods are also known. However, all of these methods are extended methods of DPLL. The basic operation of the other methods is the same as DPLL.

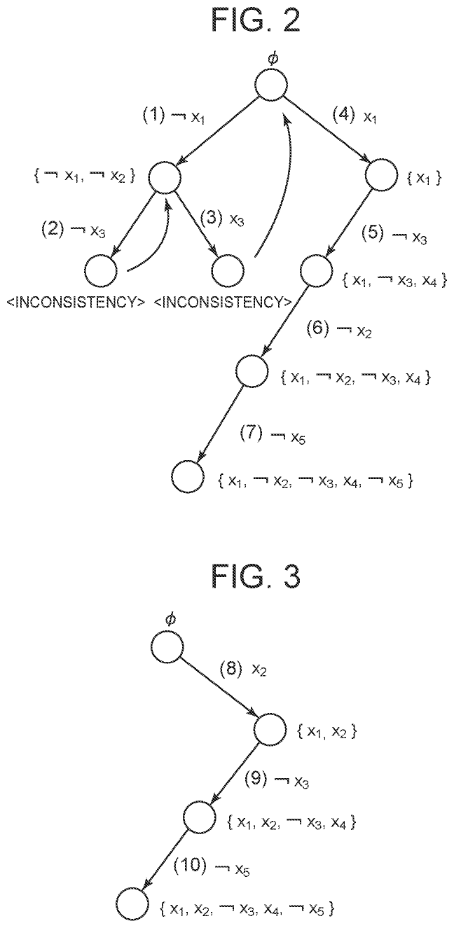

An example of the process by which the SAT solving unit 112 solves for the SAT according to the above algorithm is described with reference to FIG. 2. FIG. 2 is an explanatory diagram showing an example of the process that the SAT solving unit 112 solves for the SAT.

In the example shown in FIG. 2, the SAT solving unit 112 solves for the SAT shown in Equation (4). The (1), (2), . . . shown in FIG. 2 represent the stages of the process. The circles shown in FIG. 2 represent the states of the combination of variables at each stage.

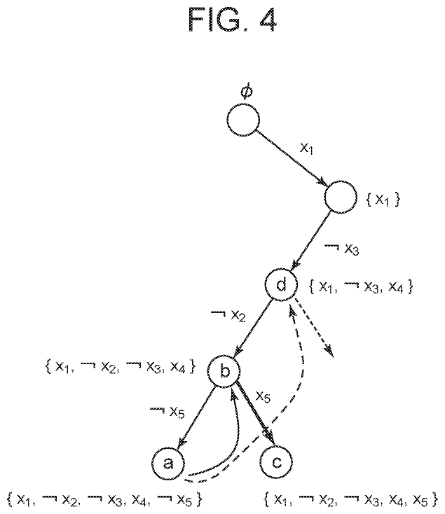

The straight arrows shown in FIG. 2 represent the setting of variables and changes in state. Also, {xᵢ, . . . } shown in FIG. 2 represents a confirmed combination of variables. In addition, ϕ shown in FIG. 2 represents the initial state, which is an empty set. The meaning of each notation shown in FIG. 2 is the same in FIGS. 3 and 4.

In the first stage (1), the SAT solving unit 112 sets x₁ to false. Once x₁ is set to false, x₂ is confirmed to false by the clause (x₁ ∧¬x₂). Thus, after stage (1), the combination of confirmed variables is {¬x₁, ¬x₂}.

In the next stage (2), the SAT solving unit 112 sets x₃ to false. Once x₃ is set to false, x₄ is confirmed to false by the clause (x₁ ∧x₃ ∧¬x₄). However, by the clause (x₃ ∧x₄), x₄ is confirmed to true.

Because the inconsistency with respect to x₄ as described above has occurred, the SAT solving unit 112 determines that x₃ was incorrectly set and backtracks to the previous state by one. Next, in stage (3), the SAT solving unit 112 re-sets x₃ to true.

Once x₃ is set to true, x₅ is confirmed to false by the clause (¬x₃ ∧¬x₅). However, by the clause (¬x₃ ∧x₅), x₅ is confirmed to true.

Because the inconsistency with respect to x₅ as described above has occurred, the SAT solving unit 112 determines that x₁ was incorrectly set and backtracks to the previous state by two. Next, in stage (4), the SAT solving unit 112 re-sets x₁ to true.

Once x₁ is set to true, there are no variables to be confirmed. Therefore, after stage (4), the combination of confirmed variables is {x₁}.

Next, in stage (5), the SAT solving unit 112 sets x₃ to false. Once x₃ is set to false, x₄ is confirmed to true by the clause (x₃ ∧x₄). Thus, after stage (5), the combination of confirmed variables is {x₁, ¬x₃, x₄}.

Next, in stage (6), the SAT solving unit 112 sets x₂ to false. Once x₂ is set to false, there are no variables to be confirmed. Thus, after stage (6), the combination of confirmed variables is {x₁, ¬x₂, ¬x₃, x₄}.

Next, in stage (7), the SAT solving unit 112 sets x₅ to false. Once x₅ is set to false, all clauses are satisfied.

Therefore, after stage (7), since the combination of variables is confirmed by {x₁, ¬x₂, ¬x₃, x₄, ¬x₅}, the SAT solving unit 112 terminates the process of solving the SAT. The process of solving the SAT is a depth-first search process, as shown in FIG. 2.

As mentioned above, the SA requires that after one variable flips from the current combination of variables, a combination (candidate solution) is obtained that satisfies the constraints while leaving the other variables unchanged as much as possible. The current combination of variables is the candidate solution {x₁, ¬x₂, ¬x₃, x₄, ¬x₅} shown in FIG. 2, or a tentative solution to the combinatorial optimization problem being solved by the SA method.

Therefore, when the simulated annealing device 100 of this example embodiment solves the combinatorial optimization problem, the SAT solving unit 112, which sets the values of the variables according to the DPLL, uses the current values of the variables as possible.

There are two methods to use the current values of the variables as possible: “1. a method of re-solving after first setting the candidate variables to be flipped”, and “2. a method of forcing backtracking on the previously generated search tree”. Each method is described below:

FIG. 3 is an explanatory diagram showing an example of searching for candidate solutions in the process of solving a combinatorial optimization problem by the SAT solving unit 112. In the example shown in FIG. 3, the SAT solving unit 112 searches for candidate solutions according to “1. a method of re-solving after first setting the candidate variables to be flipped”.

In the example shown in FIG. 3, the SAT solving unit 112 re-solves the SAT based on the candidate solution {x₁, ¬x₂, ¬x₃, x₄, ¬x₅} shown in FIG. 2. In the example shown in FIG. 3, the SAT solving unit 112 also solves the SAT shown in Equation (4).

In the example shown in FIG. 3, the SAT solving unit 112 first sets x₂ as the candidate variable to be flipped. Therefore, at stage (8), the SAT solving unit 112 sets x₂ to true.

Once x₂ is set to true, x₁ is confirmed to true by the clause (x₁ ∧¬x₂). Therefore, after stage (8), the combination of confirmed variables is {x₁, x₂}.

In the next stage (9), the SAT solving unit 112 sets x₃ to false, which was false in the previous candidate solution. Once x₃ is set to false, x₄ is confirmed to true by the clause (x₃ ∧x₄). Thus, after stage (9), the combination of confirmed variables is {x₁, x₂, ¬x₃, x₄}.

In the next step (10), the SAT solving unit 112 sets x₅ to false, which was false in the previous candidate solution. Once x₅ is set to false, all clauses are satisfied.

Therefore, after stage (10), since the combination of variables is confirmed by {x₁, x₂, ¬x₃, x₄, ¬x₅}, the SAT solving unit 112 terminates the process of solving the SAT.

Although not described in the example shown in FIG. 3, when the value of a candidate variable to be flipped is first changed, the values of variables other than the candidate variable to be flipped may also be changed to satisfy the constraint, such as in a traveling salesman problem.

If the constraint is not satisfied with the value of the variable after the flip, the value of the variable is changed after backtracking. In the example shown in FIG. 3, the constraint is not satisfied even if x₁ is set as the candidate variable to be flipped.

Specifically, if x₁ is set as a candidate variable to be flipped, i.e., x₁ is set to false, the SAT solving unit 112 sets x₁ to true according to the DPLL because no candidate solution is obtained. Finally, the SAT solving unit 112 obtains the same candidate solutions as those shown in FIG. 2.

FIG. 4 is an explanatory diagram showing another example of searching for candidate solutions in the process of solving a combinatorial optimization problem by the SAT solving unit 112. In the example shown in FIG. 4, the SAT solving unit 112 searches for candidate solutions according to “2. a method of forcing backtracking on the previously generated search tree”.

In the example shown in FIG. 4, the SAT solving unit 112 is forced to backtrack from the state in which the candidate solution {x₁, x₂, ¬x₃, x₄, ¬x₅} shown in FIG. 2 is obtained and search for another alternative. In the example shown in FIG. 4, the SAT solving unit 112 also solves the SAT shown in Equation (4).

The search tree shown in FIG. 4 consists of one or more nodes that indicate sets of values of multiple variables generated when candidate solutions to a combinatorial optimization problem are obtained. Even when the SAT solving unit 112 searches for candidate solutions based on a tentative solution to a combinatorial optimization problem that has been solved using the SA method, the search tree generated in the same way is used.

In the example shown in FIG. 4, the SAT solving unit 112 backtracks from state a, where the first candidate solution is obtained, to state b, where the variable x₅ is set. The backtrack width for backtracking from state a to state b is “1”.

Next, the SAT solving unit 112 sets x₅ to true. Once x₅ is set to true, all clauses are satisfied. Therefore, since the combination of variables in state c is confirmed by {x₁, ¬x₂, ¬x₃, x₄, x₅}, the SAT solving unit 112 terminates the process of solving the SAT.

To obtain other candidate solutions, the SAT solving unit 112 backtracks the search tree further. For example, the SAT solving unit 112 backtracks from state a, where the first candidate solution is obtained, to state d, where the variable x₂ is set. The backtrack width for backtracking from state a to state d is “2”.

In the example shown in FIG. 4, the SAT solving unit 112 searches for nodes that have not yet been generated in the search tree by solving the SAT starting from a node that indicates a tentative solution. The SAT solving unit 112 obtains the searched nodes that indicate sets of values of multiple variables as candidate solutions.

However, if the search tree is traversed too far back, the cost of solving the SAT becomes high. Therefore, if the search tree is traversed too far back, the SAT solving unit 112 re-solves the SAT and re-generates the search tree. For example, the SAT solving unit 112 changes the shape of the generated search tree by randomly changing the order of variable selection. When the shape of the search tree is changed, the variables whose values are changed after backtracking change.

It was confirmed that the simulated annealing device 100 of this example embodiment is particularly effective in solving problems such as Sudoku (registered trademark) and the nurse shift scheduling problem, where it is difficult to satisfy all of the multiple constraints imposed. It was also confirmed that “2. a method of forcing backtracking on the previously generated search tree” is about 10 times faster in solving combinatorial optimization problems than “1. a method of re-solving after first setting the candidate variables to be flipped”.

As described above, the SAT solving unit 112 of this example embodiment solves the SAT expressed in the CNF form with the constraint information indicating one or more constraints imposed on the combinatorial optimization problem converted, to obtain sets of values of multiple variables of the combinatorial optimization problem that satisfy one or more constraints, which are candidate solutions to the combinatorial optimization problem. In addition, the constraint information conversion unit 111 converts the constraint information into the SAT.

For example, the combinatorial optimization problem to be solved by the simulated annealing device 100 is the nurse shift scheduling problem.

### Description of Operation

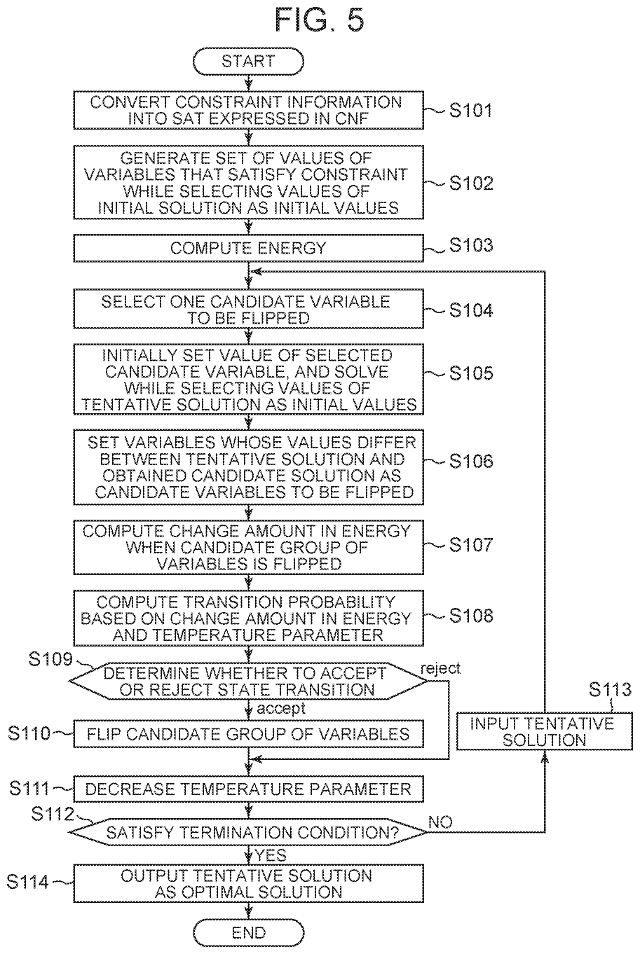

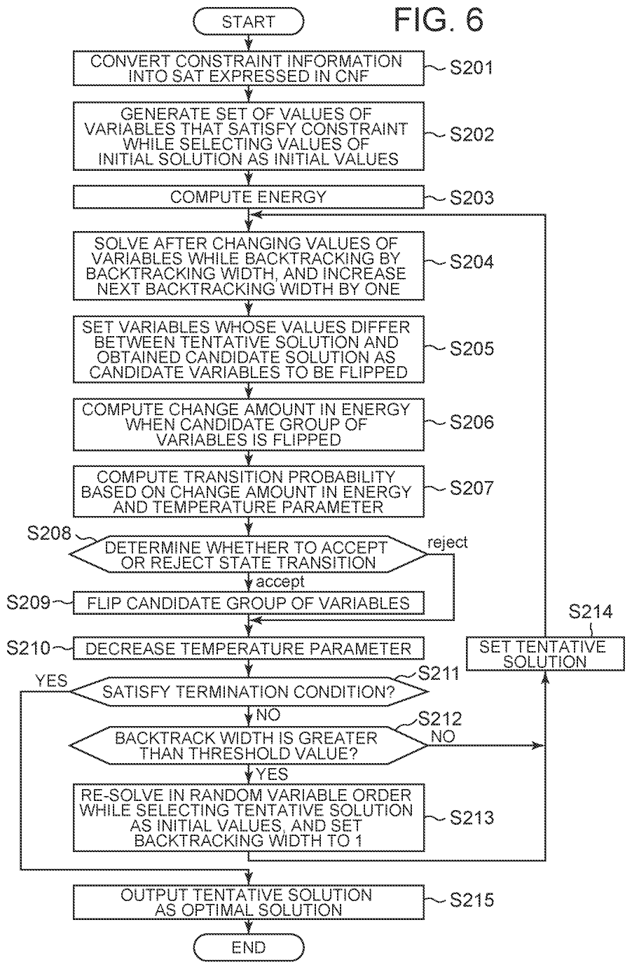

Hereinafter, the operation of the simulated annealing device 100 of this example embodiment will be described with reference to FIGS. 5-6.

FIG. 5 is a flowchart showing an operation of the combinatorial optimization problem solving process by the simulated annealing device 100 of the present example embodiment. FIG. 5 shows the combinatorial optimization problem solving process when the SAT solving unit 112 adopts the “1. a method of re-solving after first setting the candidate variables to be flipped”.

First, the constraint information of the combinatorial optimization problem to be solved is input to the constraint information conversion unit 111 of the neighbor solution generating unit 110. The constraint information conversion unit 111 converts the input constraint information into the SAT expressed in the CNF form (step S101). The constraint information conversion unit 111 inputs the generated SAT to the SAT solving unit 112.

Next, the initial solution of the generated SAT is input to the SAT solving unit 112. The initial solution of the SAT is, for example, user-specified values (true or false) or a set of randomly generated values.

The SAT solving unit 112 generates a set of values of variables that satisfy the constraints by solving for the input SAT while selecting the values of the input initial solution as initial values (step S102). For example, the process shown in FIG. 2 is the process of step S102.

The SAT solving unit 112 may solve the SAT input from an external source other than the constraint information conversion unit 111. The SAT solving unit 112 inputs the generated set of values of the variables to the energy computation unit 120.

Next, the energy computation unit 120 computes an energy based on the input set of values of the variables (step S103).

Next, the SAT solving unit 112 selects one candidate variable to be flipped from the variables included in the tentative solution (step S104). In the first iterative process, the tentative solution is the set of values of the variables generated in step S102.

Next, the SAT solving unit 112 initially sets the value of the selected candidate variable. Next, the SAT solving unit 112 solves the input SAT while selecting the values of the tentative solution as the initial values (step S105).

Next, the SAT solving unit 112 sets variables whose values differ between the tentative solution and the candidate solution obtained in step S105 as candidate variables to be flipped (step S106). Next, the SAT solving unit 112 inputs the candidate solution including the candidate group of variables to be flipped obtained to the energy computation unit 120.

Next, the energy computation unit 120 computes the change amount in energy when the input candidate group of variables is flipped (step S107). The energy computation unit 120 inputs the computed change amount in energy and a candidate solution to the transition determination unit 130.

Next, the transition determination unit 130 computes the transition probability based on the input change amount in energy and the temperature parameter (step S108).

Next, the transition determination unit 130 determines whether to accept or reject the state transition based on the computed transition probability (step S109). If it is determined that the state transition is not accepted (“reject” in step S109), the transition determination unit 130 proceeds to step S111.

If it is determined that the state transition is accepted (“accept” in step S109), the transition determination unit 130 flips the candidate group of variables included in the candidate solution (step S110). When the candidate group of variables is flipped, the candidate solution becomes a tentative solution at this time.

Next, the temperature control unit 140 decreases the temperature parameter T (step S111).

Next, the transition determination unit 130 determines whether the process of solving satisfies the termination condition (step S112). The termination condition is, for example, that the number of times processes of steps S104 to S111 have been repeatedly performed has reached a predetermined number.

If the process of solving does not satisfy the termination condition (No in step S112), the transition determination unit 130 inputs the tentative solution at this time to the SAT solving unit 112 (step S113). The SAT solving unit 112 performs the process of step S104 again.

If the process of solving satisfies the termination condition (Yes in step S112), the transition determination unit 130 outputs the tentative solution at this time as the optimal solution (step S114). After outputting the optimal solution, the simulated annealing device 100 terminates the combinatorial optimization problem solving process.

FIG. 6 is a flowchart showing another operation of the combinatorial optimization problem solving process by the simulated annealing device 100 of the present example embodiment. FIG. 6 shows the combinatorial optimization problem solving process when the SAT solving unit 112 adopts the “2. a method of forcing backtracking on the previously generated search tree”.

Each process of steps S201 to S203 is the same as each process of steps S101 to S103 shown in FIG. 5, respectively.

Next, the SAT solving unit 112 backtracks on the search tree generated when the tentative solution was solved, starting from the state where the tentative solution was obtained, by the backtracking width. In the first iterative process, the tentative solution is the set of values of the variables generated in step S202.

Next, the SAT solving unit 112 solves the input SAT after changing the values of the variables that can be changed while backtracking. After the SAT is solved, the SAT solving unit 112 increases the backtracking width by one (step S204).

Next, the SAT solving unit 112 sets variables whose values differ between the tentative solution and the candidate solution obtained in step S204 as candidate variables to be flipped (step S205). Next, the SAT solving unit 112 inputs the candidate solution including the candidate group of variables to be flipped obtained to the energy computation unit 120.

Each process of steps S206 to S211 is the same as each process of steps S107 to S112 shown in FIG. 5, respectively.

If the process of solving does not satisfy the termination condition (No in step S211), the SAT solving unit 112 determines whether the backtrack width is greater than the threshold value at this time (step S212).

If the backtrack width at this time is less than the threshold value (No in step S212), the transition determination unit 130 inputs the tentative solution at this time to the SAT solving unit 112. The SAT solving unit 112 sets the input from the transition determination unit 130 as the tentative solution (step S214) and performs the process of step S204 again.

If the backtrack width at this time is greater than the threshold value (Yes in step S212), the SAT solving unit 112 re-solves the input SAT in a random variable order while selecting the values of the tentative solution as the initial values. After the SAT is re-solved, the SAT solving unit 112 sets the backtracking width to “1” (step S213).

Next, the SAT solving unit 112 sets the candidate solution obtained in step S213 as a tentative solution (step S214). The SAT solving unit 112 performs the process of step S204 again.

If the process of solving satisfies the termination condition (Yes in step S211), the transition determination unit 130 outputs the tentative solution at this time as the optimal solution (step S215). After outputting the optimal solution, the simulated annealing device 100 terminates the combinatorial optimization problem solving process.

As described above, when adopting the “1. a method of re-solving after first setting the candidate variables to be flipped,” the SAT solving unit 112 selects one candidate variable to be flipped from the variables included in the tentative solution to the combinatorial optimization problem being solved by the SA method, changes the value of the selected candidate variable, and then solves the SAT to obtain candidate solutions to the combinatorial optimization problem.

When adopting “2. a method of forcing backtracking on the previously generated search tree,” the SAT solving unit 112 searches for nodes that have not yet been generated in the search tree consisting of one or more nodes that indicate sets of values of multiple variables generated when a tentative solution to the combinatorial optimization problem being solved by the SA method is obtained by solving the SAT starting from the node that indicates the tentative solution, and obtains the sets indicated by the searched nodes as candidate solutions.

Whichever method is adopted, the SAT solving unit 112 uses the values of the tentative solution as the initial values of the variables, and sets the variable whose value has been changed from the initial value among the variables included in the candidate solutions obtained as the candidate variable to be flipped.

The transition determination unit 130 also determines whether to accept the flipping of the candidate variables to be flipped that are included in the candidate solutions. The transition determination unit 130 flips the candidate variables that are determined to accept the flipping, and updates the tentative solution to the candidate solution to which the candidate variables have been flipped.

### Description of Effect

The simulated annealing device 100 of this example embodiment includes a constraint information conversion unit 111 that converts constraint information indicating constraints imposed on the combinatorial optimization problem to be solved into the SAT expressed in the CNF form. The simulated annealing device 100 includes a SAT solving unit 112 that solves the input SAT expressed in the CNF form.

Thus, the simulated annealing device 100 of this example embodiment can proceed with the search for a solution while satisfying all constraints imposed on the combinatorial optimization problem, because the SAT solving unit 112 can obtain candidate solutions to the combinatorial optimization problem that satisfy the constraints as a SAT solver.

By taking the above configuration, the simulated annealing device 100 of this example embodiment, even when realized on a classical computer, can solve combinatorial optimization problems on which multiple constraints are imposed more easily than the solving system described in PTL 1.

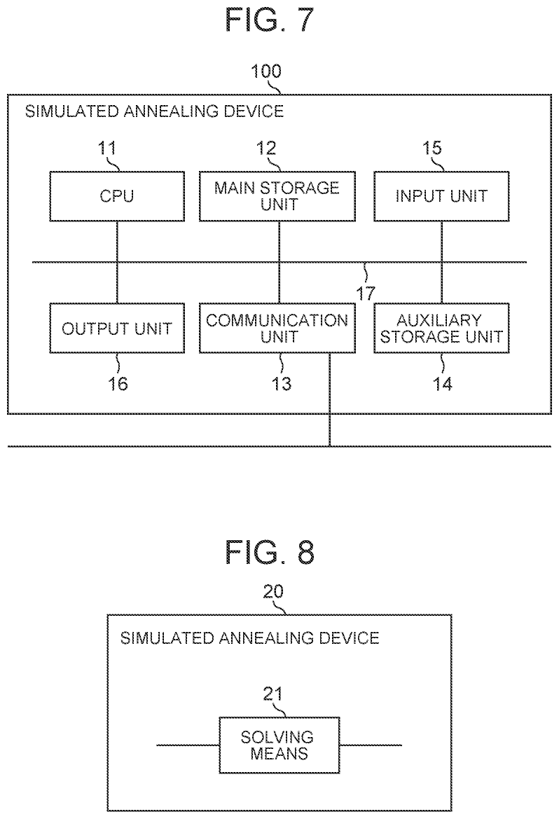

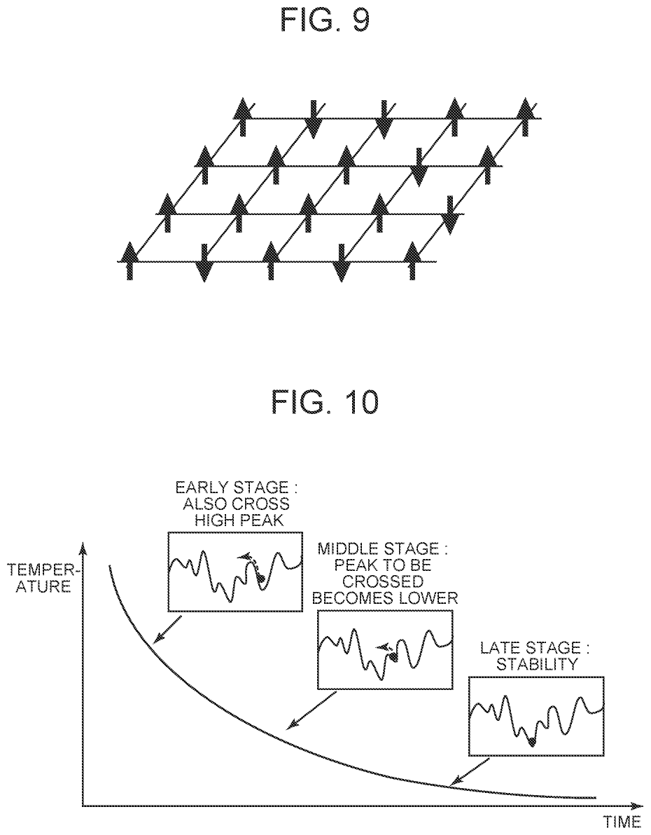

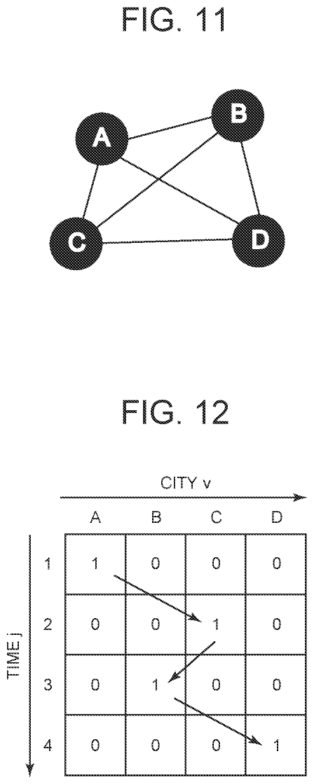

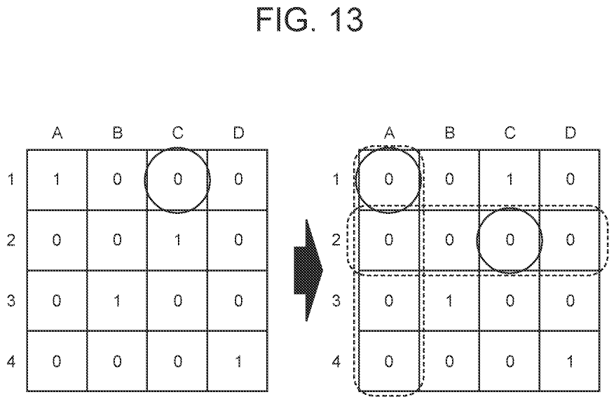

A specific example of a hardware configuration of the simulated annealing device 100 according to this example embodiment will be described below: FIG. 7 is an explanatory diagram showing an example of a hardware configuration of a simulated annealing device according to the present invention.

The simulated annealing device 100 shown in FIG. 7 includes a CPU (Central Processing Unit) 11, a main storage unit 12, a communication unit 13, and an auxiliary storage unit 14. The simulated annealing device 100 also includes an input unit 15 for the user to operate and an output unit 16 for presenting a processing result or a progress of the processing contents to the user.

The simulated annealing device 100 is realized by software, with the CPU 11 shown in FIG. 7 executing a program that provides a function that each component has.

Specifically; each function is realized by software as the CPU 11 loads the program stored in the auxiliary storage unit 14 into the main storage unit 12 and executes it to control the operation of the simulated annealing device 100.

The simulated annealing device 100 shown in FIG. 7 may include a DSP (Digital Signal Processor) instead of the CPU 11. Alternatively, the simulated annealing device 100 shown in FIG. 7 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function to output data. The output unit 16 is, for example, a display device such as a liquid crystal display device, or a printing device such as a printer.

As shown in FIG. 7, in the simulated annealing device 100, each component is connected to the system bus 17.

The auxiliary storage unit 14 stores programs for realizing the neighbor solution generating unit 110, the energy computation unit 120, the transition determination unit 130, and the temperature control unit 140 in the simulated annealing device 100.

The simulated annealing device 100 may be implemented with a circuit that contains hardware components inside such as an LSI (Large Scale Integration) that realize the functions shown in FIG. 1, for example.

The simulated annealing device 100 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

Some or all of each component of the simulated annealing device 100 may be configured by one or more information processing devices which include a computation unit and a storage unit.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be described. FIG. 8 is a block diagram showing an overview of a simulated annealing device according to the present invention. The simulated annealing device 20 according to the present invention includes a solving means 21 (for example, the SAT solving unit 112) which solves a SAT expressed in a CNF form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.

With such a configuration, the simulated annealing device can easily obtain candidate solutions that satisfy all of the multiple constraints imposed on a combinatorial optimization problem.

The simulated annealing device 20 may include a conversion means (for example, the constraint information conversion unit 111) which converts the constraint information into the SAT.

With such a configuration, the simulated annealing device can convert the constraint information into the SAT.

The solving means 21 may select one candidate variable to be flipped from variables included in a tentative solution to the combinatorial optimization problem being solved by a simulated annealing method, and solve the SAT after changing a value of the selected candidate variable to obtain candidate solutions to the combinatorial optimization problem.

With such a configuration, the simulated annealing device can easily obtain candidate solutions that satisfy all of the multiple constraints imposed on a combinatorial optimization problem.

The solving means 21 may search for nodes that have not yet been generated in a search tree consisting of one or more nodes that indicate sets of values of multiple variables generated when a tentative solution to the combinatorial optimization problem being solved by a simulated annealing method is obtained by solving the SAT, and obtain the sets indicated by the searched nodes as candidate solutions.

With such a configuration, the simulated annealing device can solve the combinatorial optimization problem faster.

The solving means 21 may use values of the tentative solution as initial values of the variables, and set the variable whose value has been changed from the initial value among the variables included in the candidate solutions obtained as a candidate variable to be flipped.

With such a configuration, the simulated annealing device can obtain the candidate solution near the tentative solution.

The simulated annealing device 20 may include a determination means (for example, the transition determination unit 130) which determines whether to accept flipping of candidate variables to be flipped that are included in the candidate solutions. The determination means may flip the candidate variables to be flipped that are determined to accept the flipping, and update the tentative solution to the candidate solution.

With such a configuration, the simulated annealing device can obtain the new solution near the tentative solution.

The combinatorial optimization problem may also be a nurse shift scheduling problem.

With such a configuration, the simulated annealing device can easily solve the nurse shift scheduling problem.

While the present invention has been explained with reference to the example embodiments and examples, the present invention is not limited to the aforementioned example embodiments and examples. Various changes understandable to those skilled in the art within the scope of the present invention can be made to the structures and details of the present invention.

### REFERENCE SIGNS LIST

11 CPU
12 Main storage unit
13 Communication unit
14 Auxiliary storage unit
15 Input unit
16 Output unit
17 System bus
20, 100 Simulated annealing device
21 Solving means
110 Neighbor solution generating unit
111 Constraint information conversion unit
112 SAT solving unit
120 Energy computation unit
130 Transition determination unit
140 Temperature control unit

What is claimed is:

1. A simulated annealing device comprising:
a memory configured to store instructions; and
a processor configured to execute the instructions to:
solve a SAT (Boolean Satisfiability Testing) expressed in a CNF (Conjunctive Normal Form) form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.

2. The simulated annealing device according to claim 1, wherein the processor is further configured to execute the instructions to:
convert the constraint information into the SAT.

3. The simulated annealing device according to claim 1, wherein the processor is further configured to execute the instructions to:
select one candidate variable to be flipped from variables included in a tentative solution to the combinatorial optimization problem being solved by a simulated annealing method; and
solve the SAT after changing a value of the selected candidate variable to obtain candidate solutions to the combinatorial optimization problem.

4. The simulated annealing device according to claim 1, wherein the processor is further configured to execute the instructions to:
search for nodes that have not yet been generated in a search tree consisting of one or more nodes that indicate sets of values of multiple variables generated when a tentative solution to the combinatorial optimization problem being solved by a simulated annealing method is obtained by solving the SAT; and
obtain the sets indicated by the searched nodes as candidate solutions.

5. The simulated annealing device according to claim 3, wherein the processor is further configured to execute the instructions to:
use values of the tentative solution as initial values of the variables; and
set the variable whose value has been changed from the initial value among the variables included in the candidate solutions obtained as a candidate variable to be flipped.

6. The simulated annealing device according to claim 3, wherein the processor is further configured to execute the instructions to:
determine whether to accept flipping of candidate variables to be flipped that are included in the candidate solutions.

7. The simulated annealing device according to claim 6, wherein the processor is further configured to execute the instructions to:
flip the candidate variables to be flipped that are determined to accept the flipping; and
update the tentative solution to the candidate solution.

8. The simulated annealing device according to claim 1, wherein
the combinatorial optimization problem is a nurse shift scheduling problem.

9. A simulated annealing method comprising:
solving a SAT (Boolean Satisfiability Testing) expressed in a CNF (Conjunctive Normal Form) form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.

10. A computer-readable recording medium recording a simulated annealing program causing a computer to execute:
solving a SAT (Boolean Satisfiability Testing) expressed in a CNF (Conjunctive Normal Form) form with constraint information indicating one or more constraints imposed on a combinatorial optimization problem converted, to obtain sets of values of multiple variables of the combinatorial optimization problem that satisfy the one or more constraints, which are candidate solutions to the combinatorial optimization problem.
